(19) United States
(12) Patent Application Publication
(10) Pub. No.: US 2024/0044484 A1
(43) Pub. Date: Feb. 8, 2024

(54) Canister System

(71) Applicant: Michael S. Brown Performance LLC, Bull Valley, IL (US)

(72) Inventor: Michael S. Brown, Bull Valley, IL (US)

(21) Appl. No.: 17/879,338

(22) Filed: Aug. 2, 2022

(51) Int. Cl. F23D 3/02

(52) U.S. Cl. CPC F23D 3/02; F23D 2202/00

(57) ABSTRACT

A canister system comprises a canister adapted to contain a liquid therein, the canister having an opening, the opening defined by a boss extending from a surface of the canister. A wick is disposed through the opening and adapted to be in contact with the liquid. A cap securely and removably attaches to the boss and covers the wick.

### FIELD OF THE INVENTION

The present invention relates generally to a cap or cover for a fuel canister having a wick extending from its interior. In particular, the present invention relates to a cap or cover for such a fuel canister wherein the cap or cover securely and removably covers and provides an airtight seal for the wick.

### BACKGROUND

Fuel burning outdoor torches are very popular and used extensively in outdoor areas, for example, to provide light, heat, and ambiance while also potentially driving away insects. Such torches typically comprise a canister for holding fuel therein, and a wick having a first end that extends outside the canister and a second end in fluid communication with the fuel inside the canister. In use, fuel is drawn up the wick, for example by capillary action, to feed a flame at the second end of the wick. The flame is typically extinguished by covering it with a cap or cover that starves the flame of oxygen.

Problems arise however because of the use environment of such torches. For example, it is common for wind or other disturbances to knock the cap or cover off of the canister thereby exposing the wick, and therefore the inside of the canister, to the rain and drying heat of the environment. Rain being absorbed into the wick or diluting the fuel within the canister can cause the wick to be difficult to light and/or to burn less robustly upon subsequent use. A need therefore exists for a cap or cover that securely yet removably attaches over the wick to prevent the cap or cover from being inadvertently and undesirably removed to expose the wick. Further, unless the cap or cover prevents airflow over the wick, then even when the wick is covered fuel can undesirably and wastefully evaporate from the second end of the wick. A further need therefore exists for the cap or cover to provide an airtight seal around the wick to prevent evaporation of the fuel.

Canisters of the sort described herein can be manufactured in a variety of different sizes as desired for their aesthetics or application. The canister size is often designated by its internal fluid volume and common sizes include without limitation 6 ounce, 10 ounce, 12 ounce, and 16 ounce fluid volume sizes, among others. The canister system as described herein is applicable to any size canister without any limitation as to the canister size.

### SUMMARY OF THE INVENTION

In one aspect of the invention, a canister system comprises a canister adapted to contain a liquid therein, the canister having an opening, the opening defined by a boss extending from a surface of the canister. A wick is disposed through the opening and adapted to be in contact with the liquid. A cap securely and removably attaches to the boss and covers the wick.

In another aspect of the invention, a canister system comprises a canister adapted to contain a liquid therein, the canister having an opening, the opening defined by a boss extending from a surface of the canister. A wick is disposed through the opening and adapted to be in contact with the liquid. A cap securely and removably attaches to the boss and covers the wick, wherein the cap securely and removably attaches to the boss by a mechanism of attachment selected from the group consisting of: one or more bayonet pins extending inwardly from an internal surface of the cap and cooperating with one or more L-shaped recesses disposed on an external surface of the boss, one or more bayonet pins extending outwardly from the external surface of the boss and cooperating with one or more L-shaped recesses disposed on the internal surface of the cap, cooperating threads on the internal surface of the cap and the external surface of the boss, a press-fit a magnetic attraction between a magnetic cap and the boss, and a magnetic attraction between a magnetic boss and the cap.

In a further aspect of the invention, a canister system comprises a canister adapted to contain a liquid therein, the canister having an opening, the opening defined by a boss extending from a surface of the canister. A wick is disposed through the opening and adapted to be in contact with the liquid. A cap securely and removably attaches to the boss and covers the wick, wherein the cap securely and removably attaches to the boss by a mechanism of attachment selected from the group consisting of: one or more bayonet pins extending inwardly from an internal surface of the cap and cooperating with one or more L-shaped recesses disposed on an external surface of the boss, one or more bayonet pins extending outwardly from the external surface of the boss and cooperating with one or more L-shaped recesses disposed on the internal surface of the cap, cooperating threads on the internal surface of the cap and the external surface of the boss, a press-fit a magnetic attraction between a magnetic cap and the boss, and a magnetic attraction between a magnetic boss and the cap. A sealing ring or gasket is disposed on a surface of the boss, on a surface of the cap, or on a surface of the canister, wherein the sealing ring or gasket is sized to be compressed between the surface of the cap and the surface of the boss or between the surface of the cap and the surface of the canister when the cap is attached to the boss.

Additional aspects and advantages of the present disclosure will become readily apparent to those skilled in this art from the following detailed description, wherein only illustrative embodiments of the present disclosure are shown and described.

### BRIEF DESCRIPTION OF THE DRAWINGS

FIG. 1 illustrates a top plan view of an exemplary canister system, according to an embodiment;

FIG. 2 illustrates a cross-sectional view of the exemplary canister system of FIG. 1 taken generally along the lines 2-2 of FIG. 1;

FIG. 3A illustrates a bottom plan view of an exemplary cap or cover, according to an embodiment;

FIG. 3B illustrates a cross-sectional view of the exemplary cap or cover of FIG. 3A taken generally along the lines 3B-3B of FIG. 3A;

FIG. 3C illustrates a side elevational view of a top portion of an exemplary canister, suitable for use with the embodiment shown in FIGS. 3A and 3B;

FIG. 3D illustrates a side elevational view of a top portion of another exemplary canister, suitable for use with the embodiment shown in FIGS. 3A and 3B;

FIG. 4A illustrates a cross-sectional view of an exemplary cap or cover taken generally along the lines 4A-4A of FIG. 2, according to an embodiment;

FIG. 4B illustrates a side elevational view of a top portion of an exemplary canister, according to yet another embodiment;

FIG. 4C illustrates a cross-sectional view of a cap or cover taken generally along the lines 4A-4A of FIG. 2 and suitable for use with the embodiment of FIG. 4B;

FIG. 5A illustrates a cross-sectional view of an exemplary cap or cover taken generally along the lines 4A-4A of FIG. 2, according to still a further embodiment;

FIG. 5B illustrates a side elevational view of a top portion of an exemplary canister, suitable for use with the embodiment shown in FIG. 5A;

FIG. 6A illustrates a cross-sectional view of an exemplary cap or cover taken generally along the lines 4A-4A of FIG. 2, according to yet a further embodiment;

FIG. 6B illustrates a side elevational view of a top portion of an exemplary canister, suitable for use with the embodiment shown in FIG. 6A;

FIG. 7A illustrates a cross-sectional view of an exemplary cap or cover taken generally along the lines 4A-4A of FIG. 2, according to several embodiments;

FIG. 7B illustrates a side elevational view of a top portion of an exemplary canister, suitable for use with the embodiments shown in FIG. 7A; and

FIG. 8 illustrates an exemplary canister system mounted within a housing on the end of a supporting rod, according to an embodiment.

Other aspects and advantages of the present invention will become apparent upon consideration of the following detailed description, wherein similar structures have similar reference numerals.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention. In the descriptions that follow identical reference numerals used to describe components of different disclosed embodiments refer to identical components that may be part of the different disclosed embodiments.

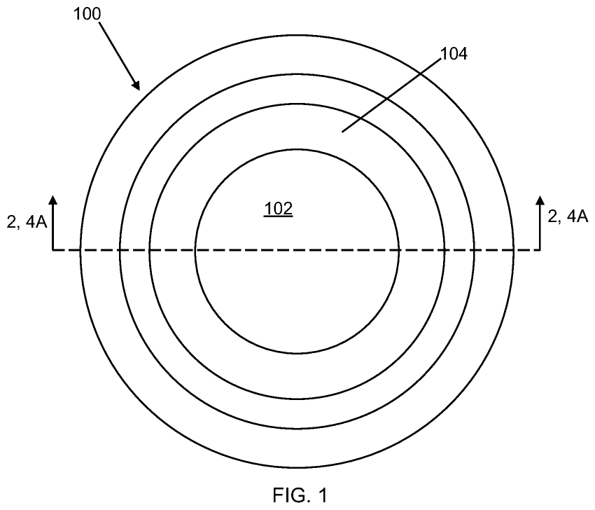

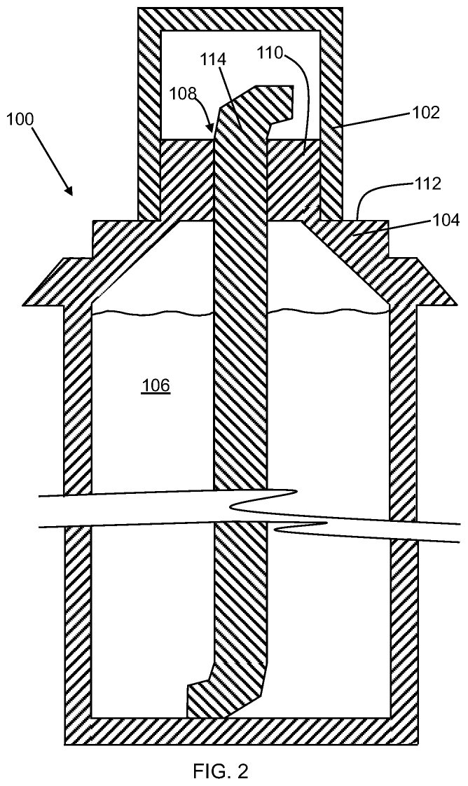

Referring to FIG. 1, an embodiment of a canister system 100 is illustrated in a top plan view as having a cap or cover 102 and a canister 104. Referring to FIG. 2, the canister system 100 is shown in a cross-sectional view taken generally along the lines 2-2 of FIG. 1. In an embodiment the canister system 100 includes the canister 104 adapted to contain a liquid 106 therein. In an embodiment the canister 104 has an opening 108, wherein the opening is defined by a boss 110 extending from a surface 112 of the canister 104. In an embodiment a wick 114 is disposed through the opening 108 and adapted to be in contact with the liquid 106. In an embodiment the wick 114 fits snugly within the opening 108 without any spaces or gaps between the wick 114 and the opening 108. In an embodiment the cap or cover 102 securely and removably attaches to the boss 110 and covers the wick 114.

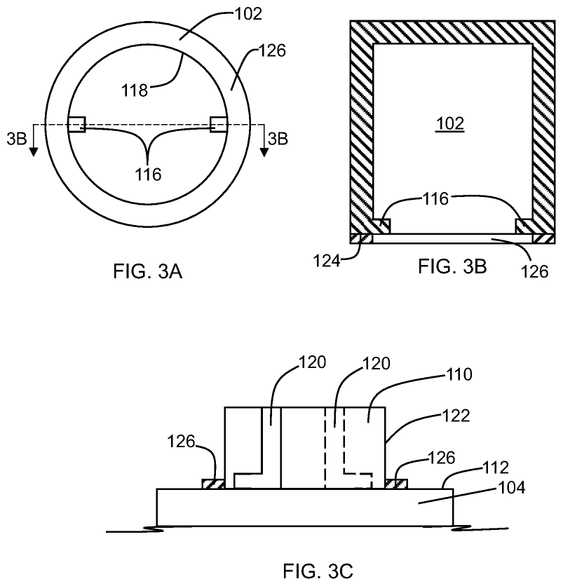

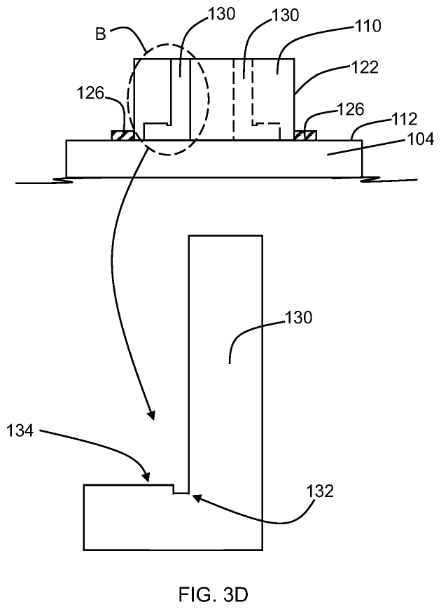

In various embodiments the cap or cover 102 securely and removably attaches to the boss by different attachment mechanisms. Referring to FIGS. 3A-3C, for example, in an embodiment the cap or cover 102 has one or more bayonet pins 116 extending inwardly from an internal surface 118 of the cap or cover 102, wherein the one or more bayonet pins 116 cooperate with one or more L-shaped recesses 120 disposed on an external surface 122 of the boss 110. The structural arrangement of the embodiment illustrated in FIGS. 3A-3C allows the cap or cover 102 to be attached to the canister 104 by lining up the one or more pins 116 with the open ends of the one or more L-shaped recesses 120, sliding the cap or cover 102 toward the canister 104 until the one or more pins 116 contacts the closed ends of the one or more L-shaped recesses 120, and rotating the cap or cover 102 so that the one or more pins 116 are captured within the one or more L-shaped recesses 120. FIGS. 3A-3C illustrate an embodiment having two pins 116 and two L-shaped recesses 120; however, in other embodiments the number of pairs of pins 116 and L-shaped slots 120 can be 1, 3, 4, 5, 6, 7, 8, or more.

Still referring to FIGS. 3A-3C, in an embodiment a gasket 126 made of compressible material is disposed on a bottom surface 124 of the cap or cover 102 or on the surface 112 of the canister 104 surrounding the base of the boss 110. The gasket 126 can be attached to the surface 112 or the surface 124 by an adhesive or by any suitable attachment mechanism as is known in the art. When the one or more pins 116 are captured within the L-shaped recesses 120, not only is the cap or cover 102 securely attached to the canister 104, but the gasket 126 is compressed so as to provide an airtight seal between the cap or cover 102 and the canister 104.

Referring to FIG. 3D, the portion of the structure within the dashed ellipse marked B is shown expanded. In this embodiment each L-shaped recess 130 has a hitch or detent 132 proximate to a top edge of the laterally extending portion 134. The hitch or detent 130 prevents undesirable inadvertent rotation of the cap or cover 102 back toward a release position once a pin 116 is locked behind it. In this embodiment, force is applied to push the cap or cover 102 against the canister 104 far enough to allow rotation of the cap or cover 102 so that each of the one or more pins 116 is positioned rotationally behind the hitch or detent 132. Upon release of the cap or cover 102 the force of compression of the gasket 126 pushes the cap or cover 102 away from the surface 112 and keep each pin 116 trapped behind the hitch or detent 132, thereby preventing undesirable rotation of the cap or cover 102 while also maintaining an airtight seal between the cap or cover 102 and the canister 104.

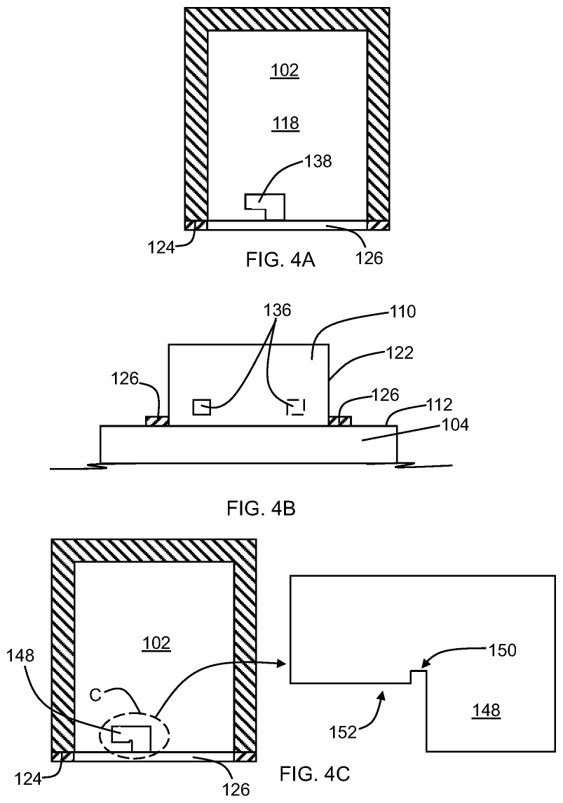

Referring to FIGS. 4A and 4B, in another embodiment one or more bayonet pins 136 extend outwardly from an external surface 122 of the boss 110, wherein the one or more bayonet pins 136 cooperate with one or more L-shaped recesses 138 disposed on the internal surface 118 of the cap or cover 102. In the embodiment illustrated in FIG. 4B the one or more bayonet pins 136 are shown to have a rectangular cross-section; however, in other embodiments both the pins 136 and the pins 116 shown in FIGS. 3A and 3B) can have any cross-sectional shape, for example without limitation, circular, elliptical, ovoid, triangular, pentagonal, hexagonal, or any regular or irregular polygonal shape. The structural arrangement of the embodiment illustrated in FIGS. 4A and 4B allows the cap or cover 102 to be attached to the canister 104 by lining up the one or more pins 136 with the open ends of the one or more L-shaped recesses 138, sliding the cap or cover 102 toward the canister 104 until the one or more pins 136 contacts the closed ends of the one or more L-shaped recesses 138, and rotating the cap or cover 102 so that the one or more pins 136 are captured within the one or more L-shaped recesses 138. FIG. 4A shows only one L-shaped recess for clarity, and FIG. 4B shows an embodiment having two pins 136; however, in other embodiments the number of pairs of pins 136 and L-shaped slots 138 can be 1, 3, 4, 5, 6, 7, 8, or more. The gasket 126 is also shown in FIGS. 4A and 4B and functions the same way as described in the prior embodiment with regard to FIGS. 3A-3C.

Referring to FIG. 4C, the portion of the structure within the dashed ellipse marked C is shown expanded. In this embodiment each L-shaped recess 148 has a hitch or detent 150 proximate to a bottom edge of the laterally extending portion 152. The hitch or detent 150 prevents undesirable inadvertent rotation of the cap or cover 102 back toward a release position once a pin 136 is locked behind it. In this embodiment, force is applied to push the cap or cover 102 against the canister 104 far enough to allow rotation of the cap or cover 102 so that each of the one or more pins 136 is positioned rotationally behind the hitch or detent 150. Upon release of the cap or cover 102 the force of compression of the gasket 126 pushes the cap or cover 102 away from the surface 112 and keep each pin 136 trapped behind the hitch or detent 150, thereby preventing undesirable rotation of the cap or cover 102 while also maintaining an airtight seal between the cap or cover 102 and the canister 104.

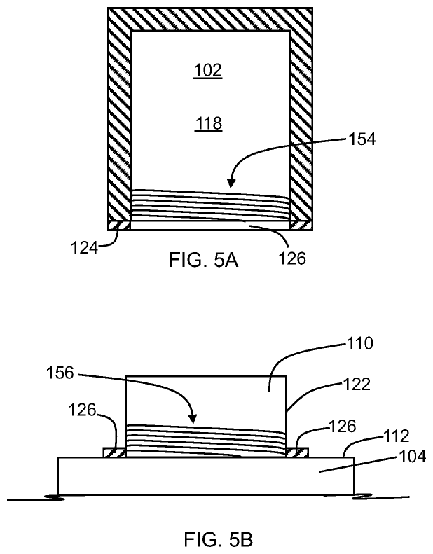

Referring to FIGS. 5A and 5B, in another embodiment threads 154 disposed on the internal surface 118 of the cap or cover 102 cooperate with threads 156 disposed on the external surface 122 of the boss 110. The gasket 126 shown in FIGS. 5A and 5B functions the same way as described in the prior embodiments with regard to FIGS. 3A-4C. The structural arrangement of the embodiment illustrated in FIGS. 5A and 5B allows the cap or cover 102 to be securely and removably attached to the canister 104 by threading the cap 102 onto the canister 104 until the gasket 126 is compressed therebetween, which also maintains an airtight seal between the cap or cover 102 and the canister 104.

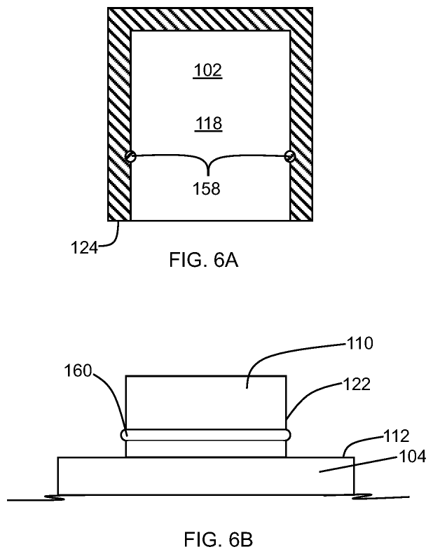

Referring to FIGS. 6A and 6B, in an embodiment a sealing ring 158, for example an O-ring 158, is disposed on the internal surface 118 of the cap or cover 102, or a sealing ring 160, for example an O-ring 160, is disposed on the external surface 122 of the boss 110, or both. The structural arrangement of the embodiment illustrated in FIGS. 6A and 6B allows the cap or cover 102 to be securely and removably attached to the canister 104 by a press-fit of the cap 102 over the boss 110 of the canister 104. The press-fit compresses either or both of the sealing rings 158, 160 that is/are present, which not only securely and removably attaches the cap or cover 102 to the canister 104, but also maintains an airtight seal between the cap or cover 102 and the canister 104.

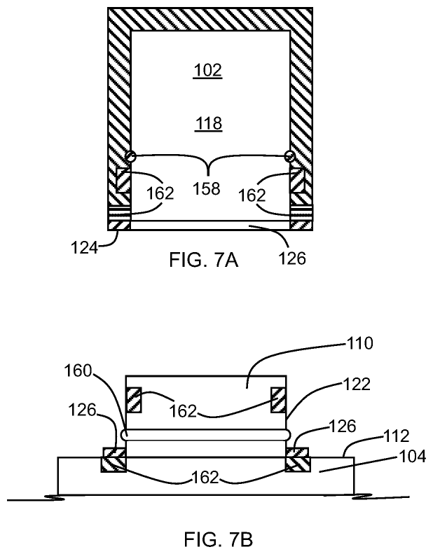

Referring to FIGS. 7A and 7B, in an embodiment the cap or cover 102 is entirely or partially made of a magnetic material producing a magnetic force of attraction and at least the boss 110 of canister 104 is entirely or partially made of a material, for example a ferromagnetic material, that is attracted by a magnetic force of attraction. In an embodiment at least the boss 110 of canister 104 is entirely or partially made of a magnetic material producing a magnetic force of attraction and the cap or cover 102 is entirely or partially made of a material, for example a ferromagnetic material, that is attracted by a magnetic force of attraction. In an embodiment at least the boss 110 of canister 104 and the cap or cover 102 are both entirely or partially made of a magnetic material producing a magnetic force of attraction. In an embodiment one or both of the cap or cover 102 and the boss 110 includes one or more magnets 162 embedded in or on one or more of their facing surfaces as schematically shown in FIGS. 7A and 7B, and the other or both of the cap or cover 102 and the boss 110 is entirely or partially made of a material, for example a ferromagnetic material, that is attracted by a magnetic force of attraction.

Still referring to FIGS. 7A and 7B, in an embodiment, the sealing ring 158, for example an O-ring 158, is disposed on the internal surface 118 of the cap or cover 102, or the sealing ring 160, for example an O-ring 160, is disposed on the external surface 122 of the boss 110, or both. In an embodiment the gasket 126 is disposed on the bottom surface 124 of the cap or cover 102 or on the surface 112. The structural arrangements of the embodiments illustrated in FIGS. 7A and 7B allow the cap or cover 102 to be securely and removably attached to the canister 104 by a magnetic attraction between a magnetic cap or cover 102 and the boss 110, by a magnetic attraction between a magnetic boss 110 and the cap or cover 102, or by a mutual magnetic attraction between a magnetic cap or cover 102 and a magnetic boss 110. Further, any of the magnetically attracted secure and removable attachments described above compresses either or both of the sealing rings 158, 160 that is/are present, and/or compresses the gasket 126 if present, which not only securely and removably attaches the cap or cover 102 to the canister 104, but also maintains an airtight seal between the cap or cover 102 and the canister 104.

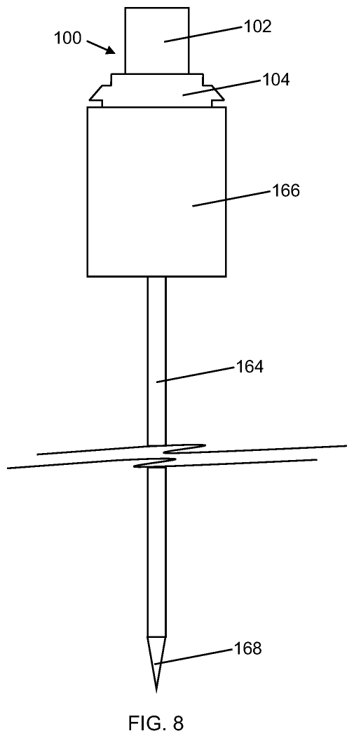

Referring to FIG. 8, in an embodiment the canister system 100 further comprises a supporting rod 164 having an open-ended housing 166 disposed on a first end of the rod 164, wherein the canister 104 is sized to be disposed within the housing 166 so that the opening 108 (not visible in FIG. 8 because it is under the cap or cover 102) is directed away from the rod 164. In an embodiment an end 168 of the supporting rod 164 opposite the open ended housing 166 is pointed to allow, for example, for easy insertion into the ground.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INDUSTRIAL APPLICABILITY

A canister system comprises a canister adapted to contain a liquid therein and a cap that securely and removably attaches to the canister to inhibit damage to the container and degradation or loss of fuel from the canister. The canister system can be manufactured in industry for use by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I claim:

1. A canister system, comprising:
a canister adapted to contain a liquid therein, the canister having an opening, the opening defined by a boss extending from a surface of the canister;
a wick disposed through the opening and adapted to be in contact with the liquid; and
a cap that securely and removably attaches to the boss and covers the wick.

2. The canister system of claim 1, further comprising a sealing ring or gasket disposed on a surface of the boss, on a surface of the cap, or on a surface of the canister, wherein the sealing ring or gasket is sized to be compressed between the surface of the cap and the surface of the boss or between the surface of the cap and the surface of the canister when the cap is attached to the boss.

3. The canister system of claim 2, wherein the sealing ring or gasket forms an airtight seal when the cap is attached to the boss.

4. The canister system of claim 1, wherein the cap securely and removably attaches to the boss by a mechanism of attachment selected from the group consisting of: one or more bayonet pins extending inwardly from an internal surface of the cap and cooperating with one or more L-shaped recesses disposed on an external surface of the boss, one or more bayonet pins extending outwardly from the external surface of the boss and cooperating with one or more L-shaped recesses disposed on the internal surface of the cap, cooperating threads on the internal surface of the cap and the external surface of the boss, a press-fit, a magnetic attraction between a magnetic cap and the boss, and a magnetic attraction between a magnetic boss and the cap.

5. The canister system of claim 4, further comprising a sealing ring or gasket disposed on a surface of the boss, on a surface of the cap, or on a surface of the canister, wherein the sealing ring or gasket is sized to be compressed between the surface of the cap and the surface of the boss or between the surface of the cap and the surface of the canister when the cap is attached to the boss.

6. The canister system of claim 5 further comprising a supporting rod having an open-ended housing disposed on an end of the rod, wherein the canister is sized to be disposed within the housing so that the opening is directed away from the rod.

7. A canister system, comprising:
a canister adapted to contain a liquid therein, the canister having an opening, the opening defined by a boss extending from a surface of the canister;
a wick disposed through the opening and adapted to be in contact with the liquid; and
a cap that securely and removably attaches to the boss and covers the wick, wherein the cap securely and removably attaches to the boss by a mechanism of attachment selected from the group consisting of: one or more bayonet pins extending inwardly from an internal surface of the cap and cooperating with one or more L-shaped recesses disposed on an external surface of the boss, one or more bayonet pins extending outwardly from the external surface of the boss and cooperating with one or more L-shaped recesses disposed on the internal surface of the cap, cooperating threads on the internal surface of the cap and the external surface of the boss, a press-fit a magnetic attraction between a magnetic cap and the boss, and a magnetic attraction between a magnetic boss and the cap.

8. The canister system of claim 7, further comprising a sealing ring or gasket disposed on a surface of the boss, on a surface of the cap, or on a surface of the canister, wherein the sealing ring or gasket is sized to be compressed between the surface of the cap and the surface of the boss or between the surface of the cap and the surface of the canister when the cap is attached to the boss.

9. The canister system of claim 8, wherein the sealing ring or gasket forms an airtight seal when the cap is attached to the boss.

10. A canister system, comprising:
a canister adapted to contain a liquid therein, the canister having an opening, the opening defined by a boss extending from a surface of the canister;
a wick disposed through the opening and adapted to be in contact with the liquid; and
a cap that securely and removably attaches to the boss and covers the wick, wherein the cap securely and removably attaches to the boss by a mechanism of attachment selected from the group consisting of: one or more bayonet pins extending inwardly from an internal surface of the cap and cooperating with one or more L-shaped recesses disposed on an external surface of the boss, one or more bayonet pins extending outwardly from the external surface of the boss and cooperating with one or more L-shaped recesses disposed on the internal surface of the cap, cooperating threads on the internal surface of the cap and the external surface of the boss, a press-fit a magnetic attraction between a magnetic cap and the boss, and a magnetic attraction between a magnetic boss and the cap; and
a sealing ring or gasket disposed on a surface of the boss, on a surface of the cap, or on a surface of the canister, wherein the sealing ring or gasket is sized to be compressed between the surface of the cap and the surface of the boss or between the surface of the cap and the surface of the canister when the cap is attached to the boss.

11. The canister system of claim 10, wherein the sealing ring or gasket forms an airtight seal when the cap is attached to the boss.
